(19) United States
(12) Patent Application Publication
(10) Pub. No.: US 2003/0217531 A1
(43) Pub. Date: Nov. 27, 2003

(54) Vertical form, fill, and seal apparatus for making several types of packages

(76) Inventors: Bruce W. Keen, Chattanooga, TN (US); Alex Hanna, Ooltewah, TN (US)

Correspondence Address: FITZPATRICK CELLA HARPER & SCINTO, 30 ROCKEFELLER PLAZA, NEW YORK, NY, 10112, US

(21) Appl. No.: 10/153,694

(22) Filed: May 24, 2002

(51) Int. Cl. B65B 9/06; B32B 31/00

(52) U.S. Cl. 53/552; 156/580

(57) ABSTRACT

A vertical form, fill, and seal apparatus for making different types of packages is provided. The packaging material travels around the outside, and the product goes through the inside, of the form-and-fill tube. A fin sealing mechanism, pleat sealing mechanism, and horizontal sealing mechanism are used in combination to make the different types of packages.

### BACKGROUND OF THE INVENTION

1. Field of the Invention

The present invention relates to an apparatus for forming, filling, and sealing products in several types of package formats.

2. Related Background Art

Vertical form, fill, and seal technology is available for making bag assemblies to hold various types of products, where the products are in either a liquid or solid state. For example, U.S. Pat. No. 5,524,418 (Thompson) relates to a method of making a package by folding a thermoplastic film web along its longitudinal axis, forming a centerfolded film web into a tube, longitudinally sealing the tube, closing a first end of the tube, filling the tube with a product, closing a second end of the tube to define a tube segment, and separating the tube segment to make a package. In Thompson, a vertical form, fill, and seal system has flexible packaging material fed from a rollstock to a forming tube, where a tube is fashioned from the sheet material into a vertically dependent, upwardly open tube having overlapping longitudinal edges. These overlapping edges are subsequently sealed together longitudinally, and the lower end of the tube is closed by a transverse heat seal or by a metal clip. At this point the tube is filled with a quantity of the product to be packaged. A second transverse heat sealing or clipping operation, typically performed after the filled tube has been downwardly advanced, completes enclosure of the product. Simultaneously with or shortly after the second transverse heat sealing or clipping step, the tube is cut. Thereafter, the tube is downwardly advanced and the cycle is successively repeated so as to form multiple packages, with each package assembly being of the same type. In Thompson, FIG. 9 also shows some of the typical components of a vertical form, fill, and seal assembly. For example, the forming collar (see, e.g., reference numeral 30) converts the packaging material from the roll assembly into the shape of a tube (see, e.g., reference numeral 32). The tube is drawn down across a sealing/sizing ring (see, e.g., reference numeral 34), where a sealing means (see, e.g., reference numeral 36) creates a continuous longitudinal lap seal. The tube then travels downwardly outside a central filling mandrel (see, e.g., reference numeral 40), across a film spreader ring (see, e.g., reference numeral 42) having spreader fingers (see, e.g., reference numeral 44). The tube is drawn down by means of two pairs of drive wheels (see, e.g., reference numerals 46a and 46b showing one pair of drive wheels). The pairs of drive wheels catch and draw the edge of the tube. The tube is clipped at its lower end, filled with its product from the filling mandrel, and clipped above the product, to define a tube segment (see, e.g., reference numeral 50). The tube segment is separated from the trailing tube to produce a package.

U.S. Pat. No. 6,237,308 131 (Quintin et al.) relates to a high-speed pouch forming, filling, and sealing machine, and method of operation using a new multi-layer film structure that is used for packaging consumable liquid products, such as products including milk, sour cream, and yogurt in flexible plastic pouches. In Quintin et al., FIG. 1 shows the filler tube (see, e.g., reference numeral 17), packaging material (see, e.g., reference numeral 12), pouch former (see, e.g., reference numeral 14), vertical sealer (see, e.g., reference numeral 19), horizontal sealing jaw assembly (see, e.g., reference numeral 23), and discharge conveying means (see, e.g., reference numeral 26).

U.S. Pat. No. 5,551,208 (Van Erden) relates to a method for applying a zipper to packaging material on a tube in a form, fill, and seal system. In Van Erden, FIG. 1 shows the plastic sheet material (see, e.g., reference numeral 10) that is directed toward a filling tube (see, e.g., reference numeral 12) and associated forming collar (see, e.g., reference numeral 14), which guides the plastic sheet material around the filling tube to form a tube from the plastic sheet material.

U.S. Pat. No. 4,993,212 (Veoukas) relates to a method and apparatus for guiding a film in a form, fill, and seal package making machine. In FIG. 1, a form-and-fill tube (see, e.g., reference numeral 10) serves as a nozzle for directing product from a supply delivered into the upper end of the tube into packages which are formed in the operation of the machine from package-making material (see, e.g., reference numeral 11) supplied from a source to the machine and more particularly, to a forming collar (see, e.g., reference numeral 12). While traveling over the forming collar, the package material is formed into essentially a tubular shape around the tube and is drawn progressively downward along the tube by a customary sealing and pull-down mechanism functioning below the lower or discharged end of the tube. At completion of the tubular shaping of the bag making material, longitudinal side edge portions are brought into fin-like lapping relation to form a seal closure (see, e.g., reference numeral 13) along the length of the now tubular film. As the tubular material advances down the tube, the fin-like lapping seam (see, e.g., reference numeral 14 showing the arrows) will be sealed accordingly.

U.S. Pat. No. 5,014,498 (McMahon) relates to an apparatus and method for making and filling bags from plastic film, wrapping the plastic film around a form-and-fill tube, and controlling the feed of the film over a sharp edge of a forming tube so that a tension free slack is maintained in the film to eliminate the possibility of distortion or damage to the film. In McMahon, FIG. 1 shows a continuous length of film (see, e.g., reference numeral 10) fed forwardly and downwardly over a forming tube (see, e.g., reference numeral 11). The forming tube is hollow and open at the top so that the contents can be dropped into the tubular pouch which is formed from the film.

In McMahon, FIG. 1 also shows that the film is drawn forward by suitable means such as drive belts (see, e.g., reference numerals 12 and 13) which engage the surface of the film at opposite sides of the forming tube. As an alternative, the film may be pulled downward by cross-seaming devices (see, e.g., reference numerals 14 and 15) which move together to clamp the film and form a side seam (see, e.g., reference numeral 16) on the bag. The film has rib and groove interlocked profiles on the side opposite the bottom seam (see, e.g., reference numeral 9) in the film. The bottom seam is formed by a seaming device (see, e.g., reference numeral 17) which heat seals the film edges (see, e.g., reference numerals 10a and 10b). The belts for drawing the film downward over the tube are driven by a suitable mechanism, which is activated incrementally as the film is advanced.

U.S. Pat. No. 5,046,300 (Custer et al.) relates to a method and an apparatus for applying a reclosable zipper to a packaging film. FIG. 1 shows a sheet of packaging film (see, e.g., reference numeral 15) released from an apparatus (see, e.g., reference numeral 12) and formed into a reclosable package. The form, fill, and seal apparatus (see, e.g., reference numeral 10) of FIG. 1 includes a central member made up of a forming shoulder (see, e.g., reference numeral 20), a forming tube (see, e.g., reference numeral 22), and a product fill tube (see, e.g., reference numeral 24).

Other U.S. patents describe a method and/or apparatus using a vertical form, fill, and seal apparatus for making packages. For example, U.S. Pat. No. 5,127,208 (Custer et al.) relates to a method and apparatus for applying a reclosable zipper to a packaging film. U.S. Pat. No. 5,425,216 (Ausnit) relates to a method for forming a reclosable package on a conventional form, fill, and seal machine. U.S. Pat. No. 5,505,037 (Terminella et al.) relates to a vertical form, fill, and seal machine that makes reclosable bags of different sizes, but not different types of bags using the same apparatus, as provided by the present invention. U.S. Pat. No. 5,564,259 (Stolmeier) relates to a method and apparatus for forming a resealable tubular form fill package and shows in FIG. 1 the typical components of a vertical form, fill, and seal apparatus.

The references discussed above do not disclose or suggest an apparatus capable of producing a plurality of package types with minimal modifications of the apparatus. Such a vertical form, fill, and seal apparatus would be highly desirable.

### SUMMARY OF THE INVENTION

The present invention is directed to a vertical form, fill, and seal apparatus for making packages. The apparatus includes a vertical form and fill tube and a first sealing mechanism positioned on a first side of the tube. The apparatus also includes a second sealing mechanism positioned on a second side of the tube, where the second side of the tube is different from the first side of the tube, and at least one horizontal sealing mechanism.

### BRIEF DESCRIPTION OF THE DRAWINGS

FIG. 1 is a view showing major components of a first embodiment of the present invention.

FIG. 2 is a different perspective view showing major components of the embodiment of FIG. 1.

FIG. 3 is a view showing a side view, partly in cross-section, of the components shown in FIG. 1.

FIG. 4 is a view showing an overhead view of the components shown in FIG. 1.

FIG. 5 is a view showing a right side, frontal view of the components of the form-and-fill assembly of a first embodiment.

FIG. 6 is a close-up view of the components shown in FIG. 5.

FIG. 7 is a rear view of the forming shoulder, form-and-fill tube, and vacuum belt assembly of the form-and-fill assembly of the first embodiment.

FIG. 8 is a different perspective of the components shown in FIG. 7.

FIG. 9 is a rear view of the components of the form-and-fill assembly of the first embodiment.

FIG. 10 is a close-up view of the components shown in FIG. 9.

FIG. 11 is a frontal view of the components of the seal assembly of a first embodiment.

FIG. 12 is a different perspective view of the components of the seal assembly shown in FIG. 11.

FIG. 13 is a view showing two opposing seal head stations of a first embodiment, with the jaws in the cut position.

FIG. 14 is a view showing one seal head station of a first embodiment.

FIG. 15 is a view from the bottom of the seal head station of the first embodiment.

FIG. 16 is a view from the top of the seal head station of the first embodiment.

FIG. 17 is a sectional view of the seal head station of the first embodiment.

FIG. 18 is a view showing the orthogonal velocity mechanism of the first embodiment.

FIG. 19 is a view showing a sectional view of the orthogonal velocity mechanism of the first embodiment.

FIG. 20 is a view of the stand-up pouch made by the first embodiment.

FIG. 21 is a view of the can-type bag made by the second embodiment.

FIG. 22 is a view of the pillow type bag made by the third embodiment.

FIG. 23 is a view of the tetrahedral type bag made by the fourth embodiment.

### DETAILED DESCRIPTION OF THE PREFERRED EMBODIMENTS

The vertical, form and fill apparatus of this invention may be employed for making various types of packages such as, for example, a stand-up pouch, a can-type pouch, a pillow-type pouch or a tetrahedral-type package.

As used herein, the words “pouch”, “bag”, and “package” may be used interchangeably, with each word referring generally to a flexible container that is closed for holding or storing a product.

The apparatus of this invention includes a vertical form and fill tube having a first sealing mechanism positioned on a first side of the tube and a second sealing mechanism on a second side of the tube that may be different than the first side. In addition, the apparatus includes at least one horizontal sealing mechanism. Significantly, the type of first and second sealing mechanism may be readily varied to vary the type of package to be produced. If desired, more than one horizontal sealing mechanism may be used, most preferably positioned perpendicular to each other if a tetrahedral package is desired. In a preferred embodiment of this invention the horizontal sealing mechanism also includes a cutting mechanism. The form and fill tube of the present invention may take any shape or form that allows a flexible packaging material drawn across the tube to be formed into a substantially tubular shape. As used herein, it should be clear that the tube does not necessarily have to be cylindrical nor does it have to have a continuous surface. For example, the tube may consist of two circular metal rings lying in two different horizontal planes that are attached to and separated by one or more vertical supports. The tube, regardless of the form it takes, must only be able to support the packaging material and allow for the formation of a desired shape while providing a conduit by which a partially sealed package may be filled. Preferred tubes of the apparatus are described in more detail herein.

The first and second sealing mechanisms positioned on the side of the vertical, form and fill tube may be the same or different. As used herein, a sealing mechanism is a mechanism that allows two surfaces of a packaging material to be joined together. Preferably the first and second sealing mechanism are independently either a fin seal mechanism or a pleat seal mechanism. As used herein, a fin seal means a type of seal created when the first and second lateral edges of a film are brought together to form a fin seal extending longitudinally along the filling tube and outwardly therefrom. In addition, a pleat seal may be single or dual, and means a type of seal created when a fold in the film is made by doubling the film over on itself to form a pleat seal extending longitudinally along the filling tube and outwardly therefrom. If a pleat is dual then two parallel single pleats are formed.

The at least one horizontal sealing mechanism of this invention creates a horizontal seal across the packaging material after the packaging material has been drawn over the vertical, form and fill tube and sealed by the first and second seal mechanisms which form vertical seals in the packaging material. After a first horizontal seal is made on the package material the ingredients to be placed in the package are communicated to the package through the tube. Thereafter, a final seal is made in the package by the same or different horizontal sealing mechanism. As noted previously, the horizontal sealing mechanism will preferably include a cutting element so that the filled and finished packages are separated from each other. Of course, if desired, the separating of the packaging material may be accomplished downstream from the apparatus of this invention.

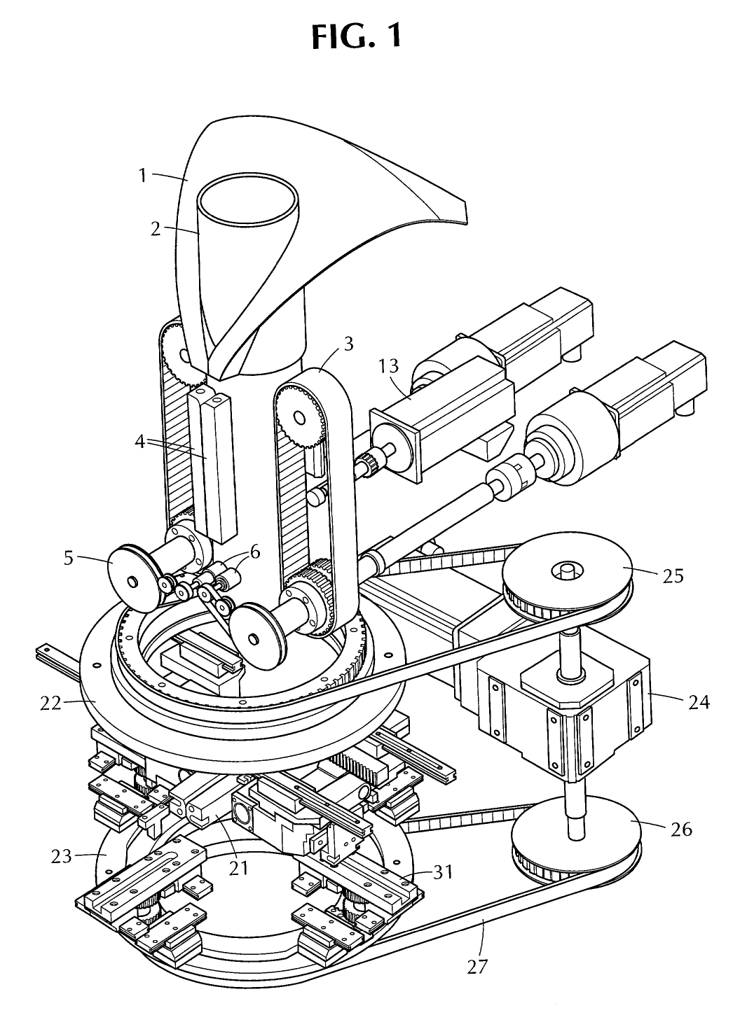

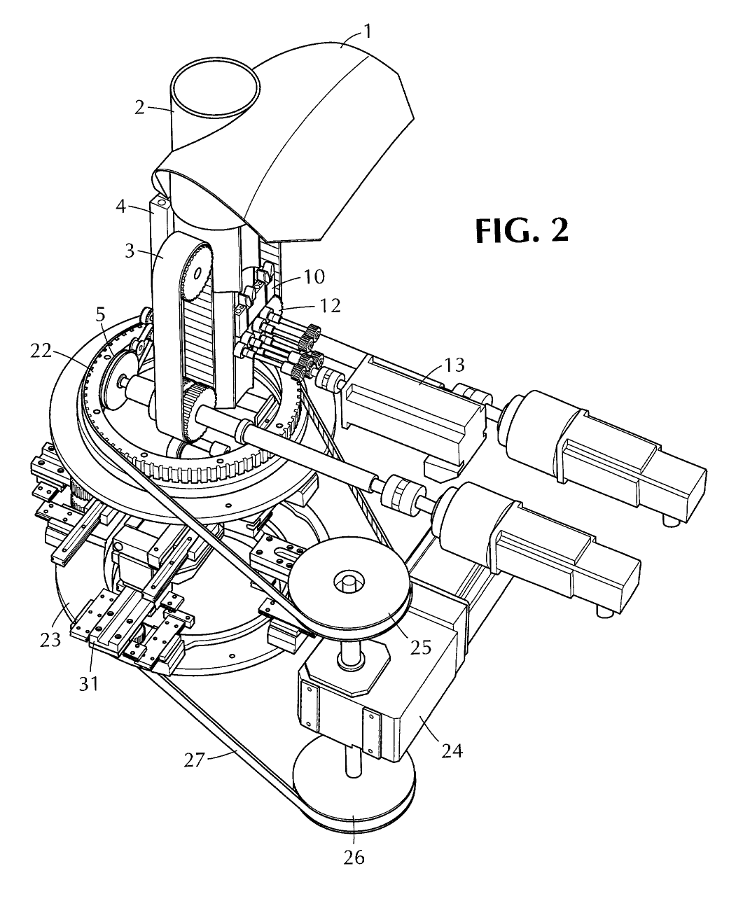

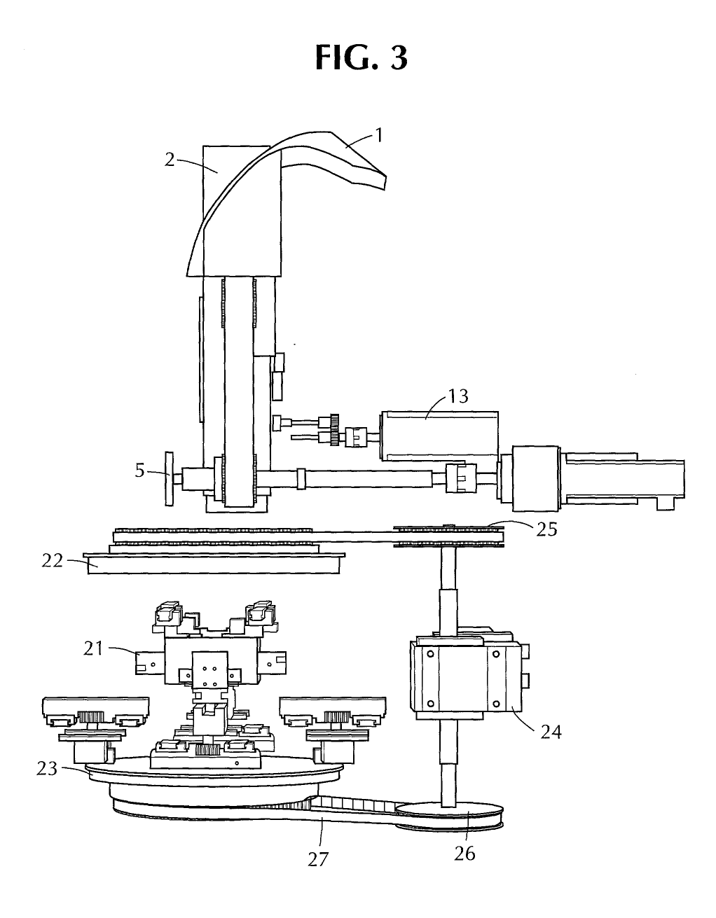

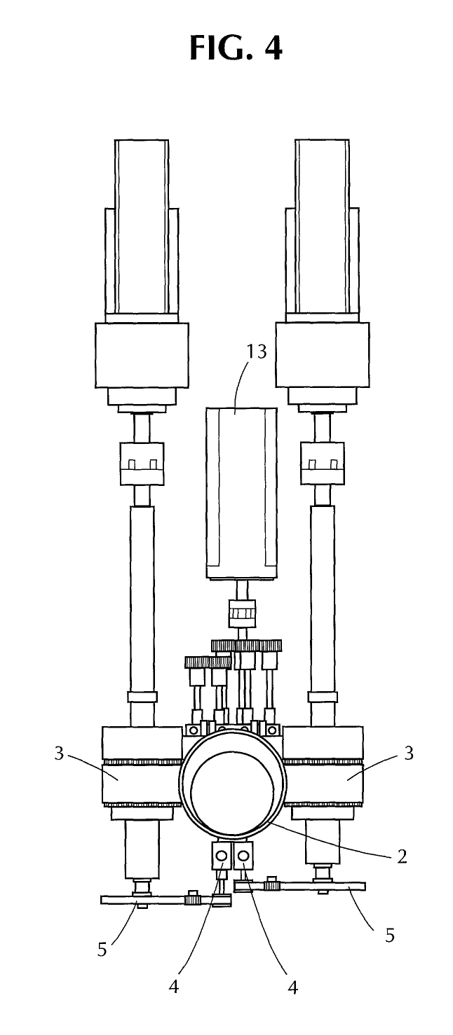

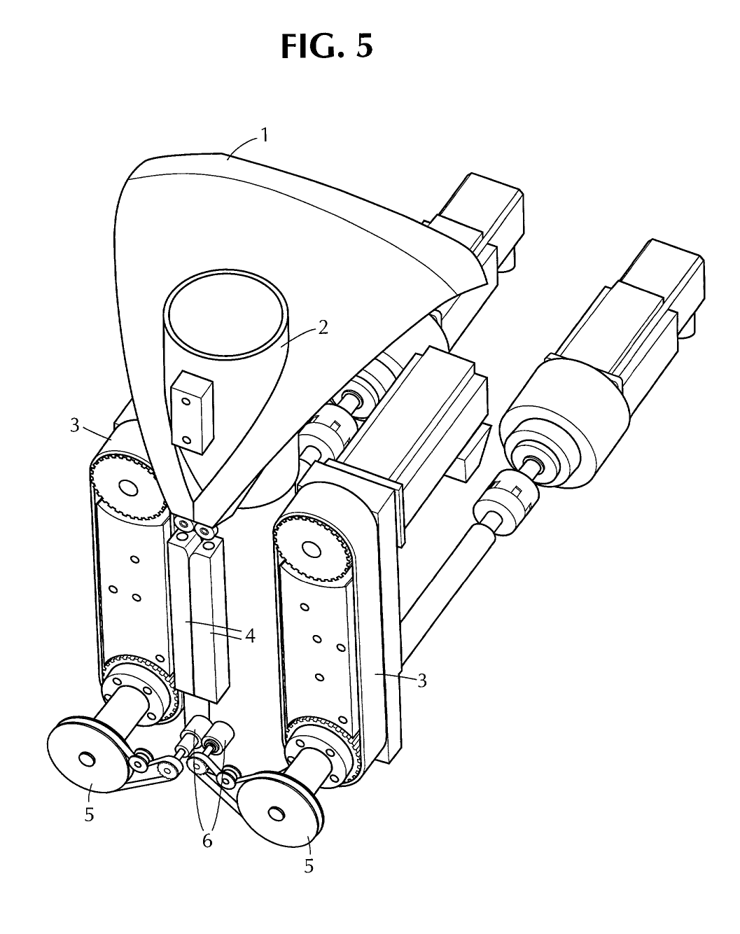

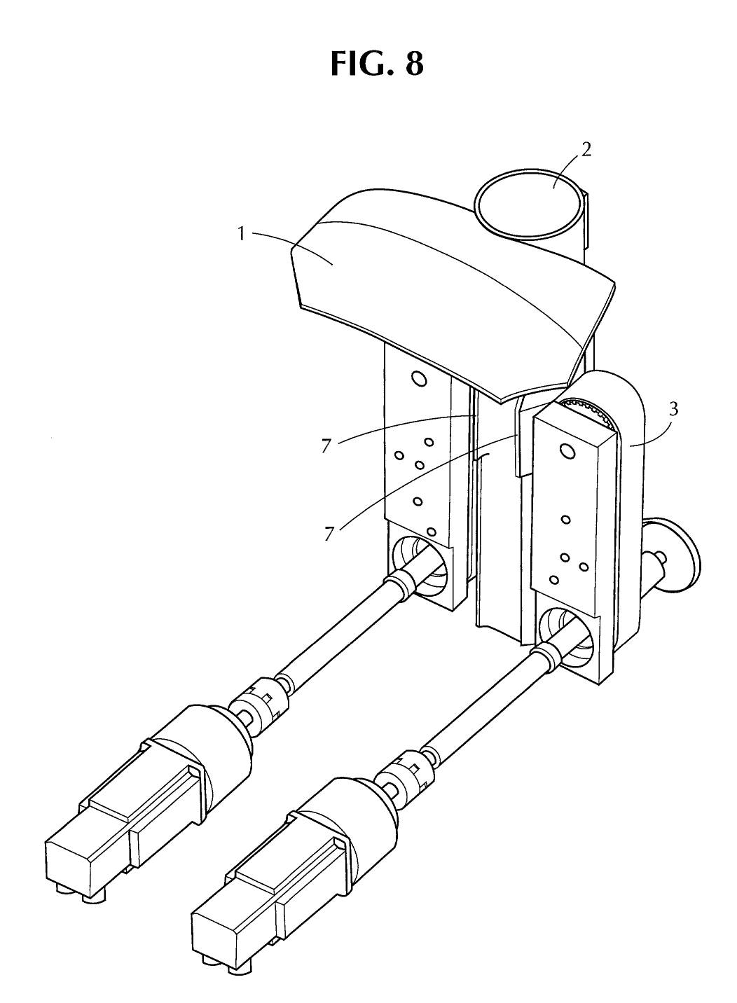

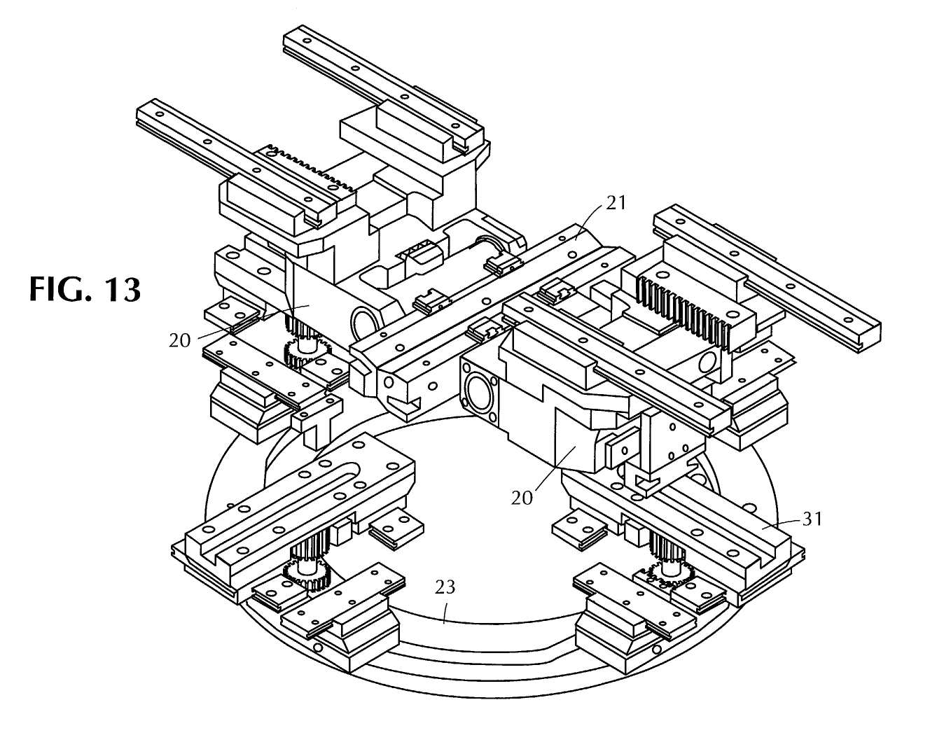

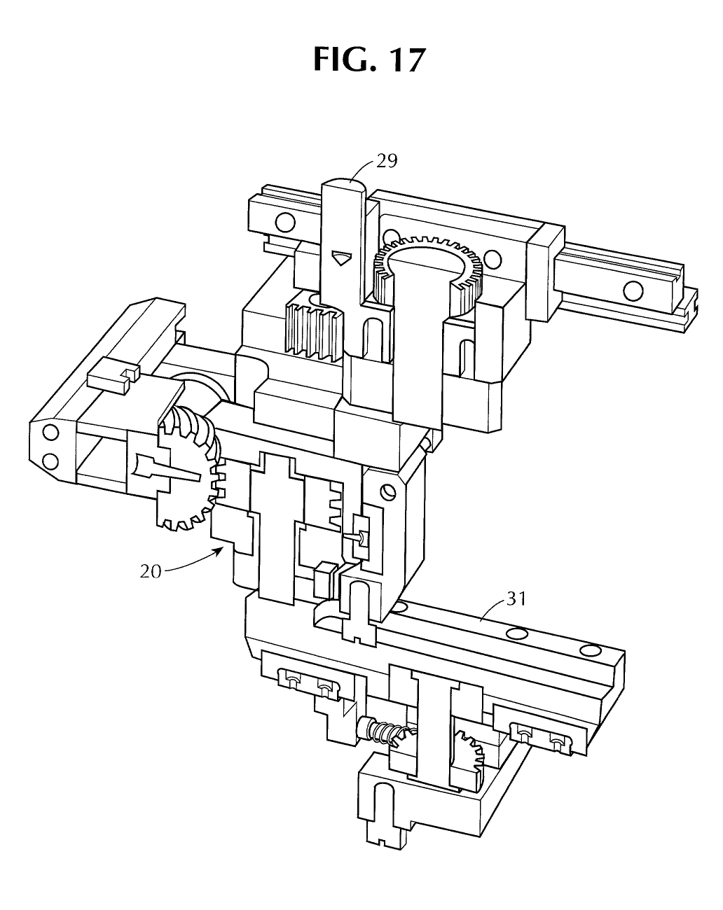

FIGS. 1-4 are different views of the major components of the apparatus of the present invention used to make a stand-up pouch and will be used to provide a more general description of the first embodiment of the present invention. FIGS. 5-10 and FIGS. 11-19 are different views of the form-and-fill assembly and horizontal sealing apparatus, respectively, and will be used to provide a more detailed description of the first embodiment of the present invention.

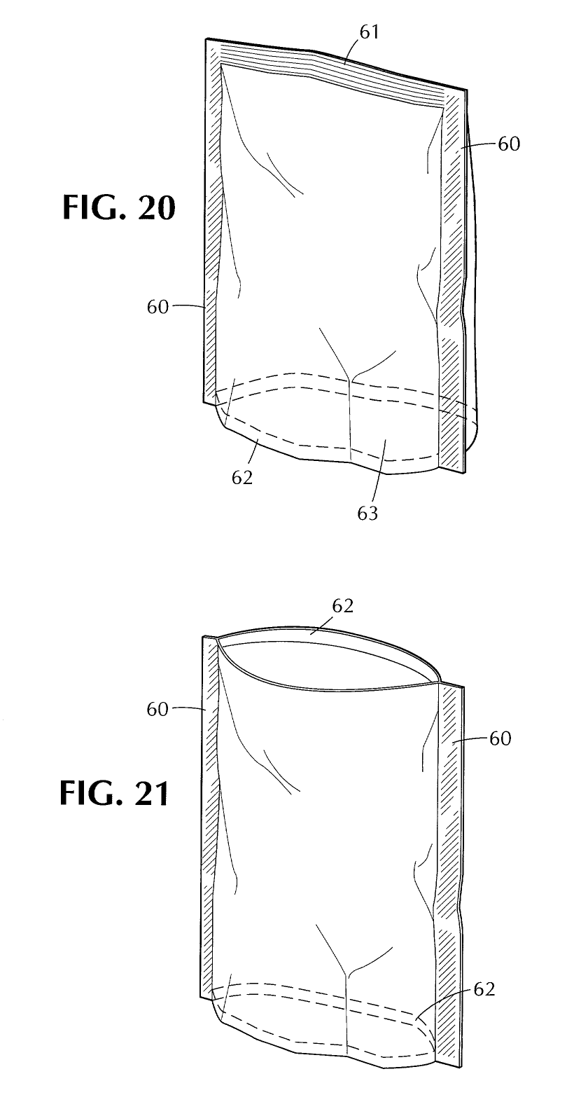

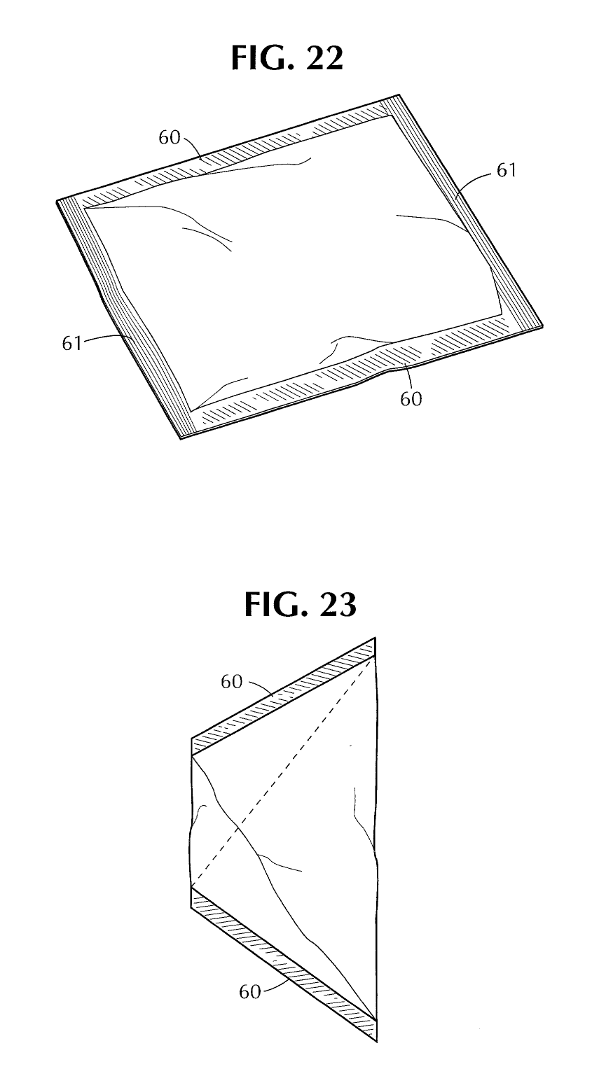

Referring to FIGS. 1-4, a film (not shown) is fed from a rollstock (not shown). The preferred mode of operation supplies the film continuously, but the film may be provided intermittently as well. The film first comes upon the forming shoulder 1, which is specific to the form-and-fill tube 2, that is, the type of forming shoulder 1 and form-and-fill tube 2 used depends on the type of package to be produced. For example, the first preferred embodiment of the present invention relates to making a stand-up pouch (shown in FIG. 20), thus the forming shoulder 1 and form-and-fill tube 2 shown in FIG. 1 uses a fin seal assembly 4 in the front of the form-and-fill tube 2 and a pleat seal assembly in the back of the form-and-fill tube 2. In the second preferred embodiment of the present invention, which is used to make a can-type pouch (shown in FIG. 21), a pleat seal assembly is used in the front and back of the form-and-fill tube 2. In the third preferred embodiment of the present invention, which is used to make a pillow-type pouch (shown in FIG. 22), a fin seal assembly 4 is used in the front and back of the form-and-fill tube 2. In the fourth embodiment of the present invention, which is used to make a tetrahedral-type package (shown in FIG. 23), a single pleat seal assembly is used in the front of the form-and-fill tube 2.

Referring to FIGS. 1-4, the forming shoulder 1 directs the film to the outer circumference of the form-and-fill tube 2, where the film conforms to the specific diameter of the form-and-fill tube 2, and positions the edges of the film in the desired location to perform the desired seal on the film. In general, a form-and-fill tube 2 forms the film around the form-and-fill tube 2 and the product being packaged flows through the inside of the form-and-fill tube 2 and into the package. The product can be supplied by common, known in the art, means such as weighing the product on a scale and dropping the product into the package, or measuring a volumetric portion of the product and dropping the portion into the package. The form-and-fill tube 2 keeps the film from collapsing on itself as it proceeds downward and also provides a backing support for the vacuum belts 3, which engage the film and feed the film downward. At this point, a fin seal 61 and a pleat seal 62 has been formed on the top and bottom of the pouch of the first embodiment, as shown in FIG. 20, and the pouch travels into the horizontal sealing mechanism of the present invention. The horizontal sealing mechanism includes either one pair or two pair of jaws 21 that travel horizontally, in an inward and outward manner, and rotate vertically, to seal and cut the packages. The inward and outward movement of the jaws 21 are controlled by the head stroke disk cam 22 while the vertical rotation of the jaw 21 is controlled by jaw rotation disk cam 23. The jaws 21, when in the mating position, will either seal the package when the jaws 21 are in their uppermost position or will cut the package when the jaws 21 are in a parallel position. The movement of the head stroke disk cam 22 and jaw rotation disk cam 23 is controlled by a common seal head servo motor 24 through drive pulleys and timing belts. In the first, second, and third embodiments of the present invention, one pair of the jaws 21 are used to create the side seal 60 in the stand-up pouch, as shown in FIGS. 20-22, and almost simultaneously after the side seal 60 is created, the jaws 21 may be rotated into the parallel, cutting position, and the package will be cut. In the fourth embodiment, two pair of the jaws 21 are used to create the top and bottom seals of the tetrahedral package, where each pair of the jaws 21 is about 90 degrees apart from each other.

FIG. 5 shows the vertical form-and-fill tube 2 of the first embodiment used to make a stand-up type pouch. The vertical form-and-fill tube 2 directs the film to the outer circumference of the form-and-fill tube 2, where the film conforms to the specific diameter of the form-and-fill tube 2, and positions the edges of the film in the desired location. The vertical form-and-fill tube 2 not only forms the tube on its outer circumference and serves as the pathway for the product to enter the package, but the vertical form-and-fill tube 2 of the first preferred embodiment transitions the film from the outer circumference of the form-and-fill tube 2 to a profile of the stand-up package in a manner that maximizes the inside diameter of the forming tube to ensure a smooth flow of product into the film.

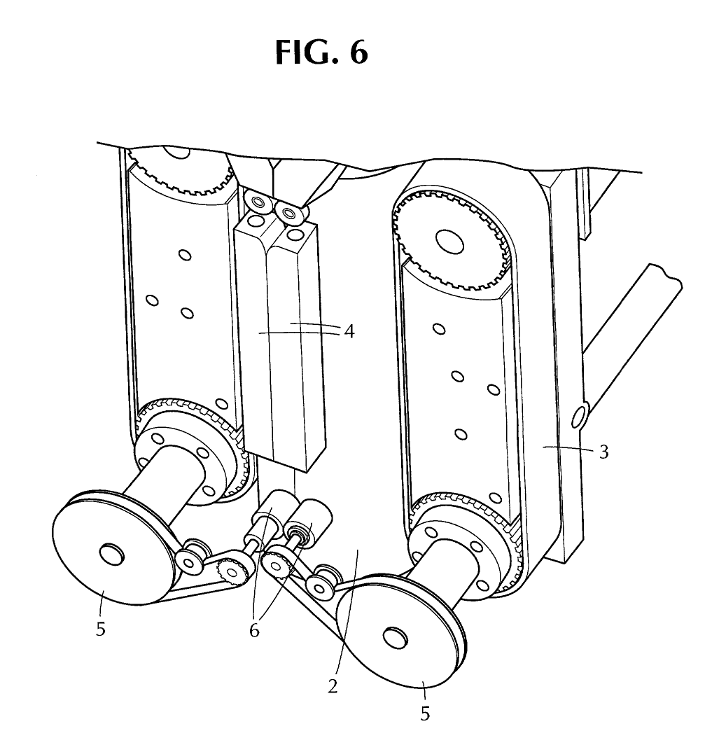

FIG. 6 shows a close-up view of the form-and-fill assembly that produces the fin seal at the top of the stand-up pouch. As the film comes off the forming shoulder 1, the edges of the film are brought together like a fin, with each edge laying on top of the other, which creates the fin seal at the top of the bag in the longitudinal direction. This length of the fin seal is the remainder of the width of the film after it is wrapped around the form-and-fill tube 2. The fin travels through the two parallel heating blocks 4, which heat the film and provide some pressure on the film as it travels downward. After the fin leaves the heating blocks, it is pulled by the modular fin seal assembly 5. The modular fin seal assembly 5 includes nip rollers 6 that compress the heated film at it is pulling it downward, and this compression leads to the desired fin seal.

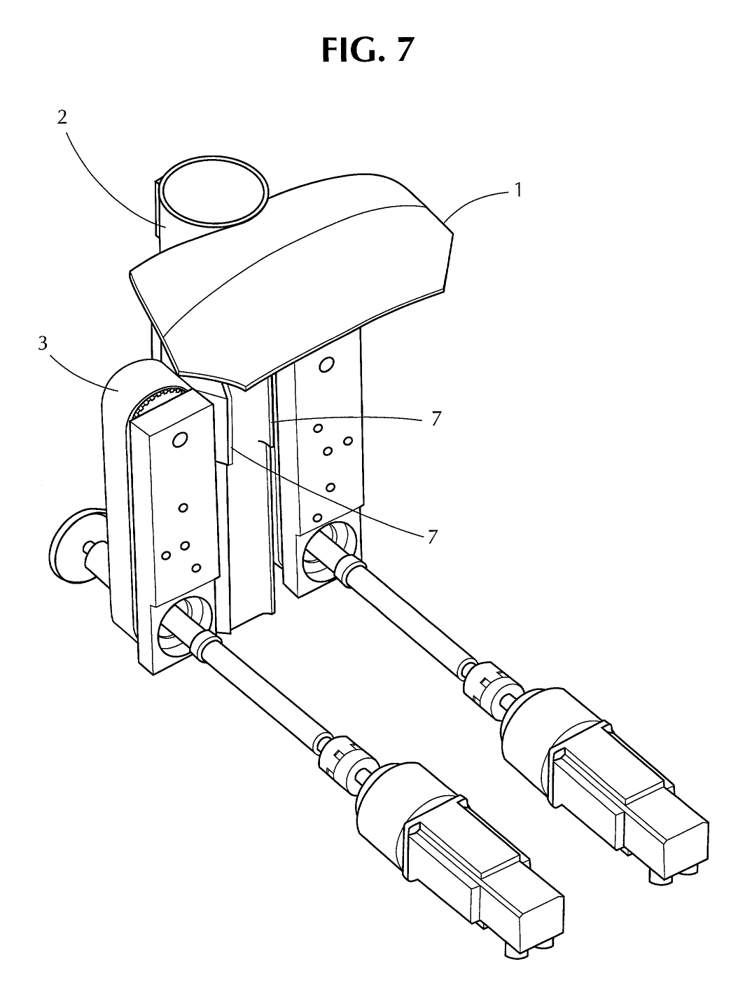

FIG. 7 shows the forming shoulder 1, form-and-fill tube 2, and vacuum belt assembly 3 of the form-and-fill assembly of the first embodiment that is used to make a stand-up pouch. FIG. 7 also shows that the outer circumference of the form-and-fill tube 2 that is used for making the stand-up type pouches is specially designed to include two raised, straight edges (hereinafter referred to as “ears” 7) that are located on the tube and are tapered from the upper to the lower section of the tube. A flat, horizontal surface located between these two ears provides support for the various components of the pleat seal assembly (described below) and is used to create the pleat seal in the bottom part of the stand-up pouch, as shown in FIG. 20.

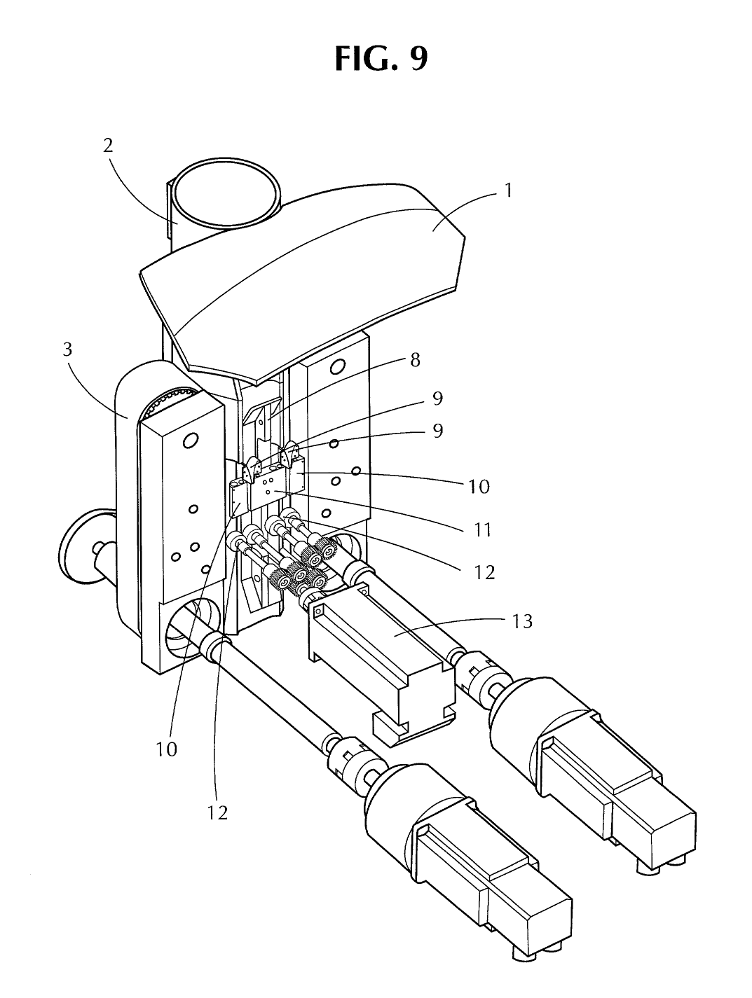

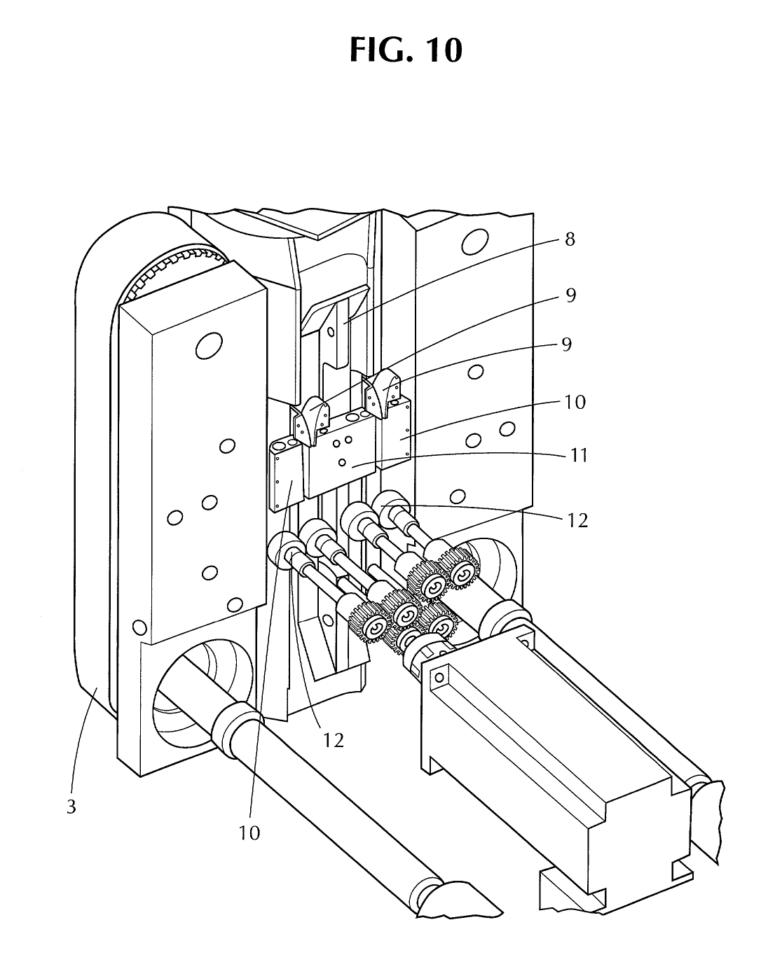

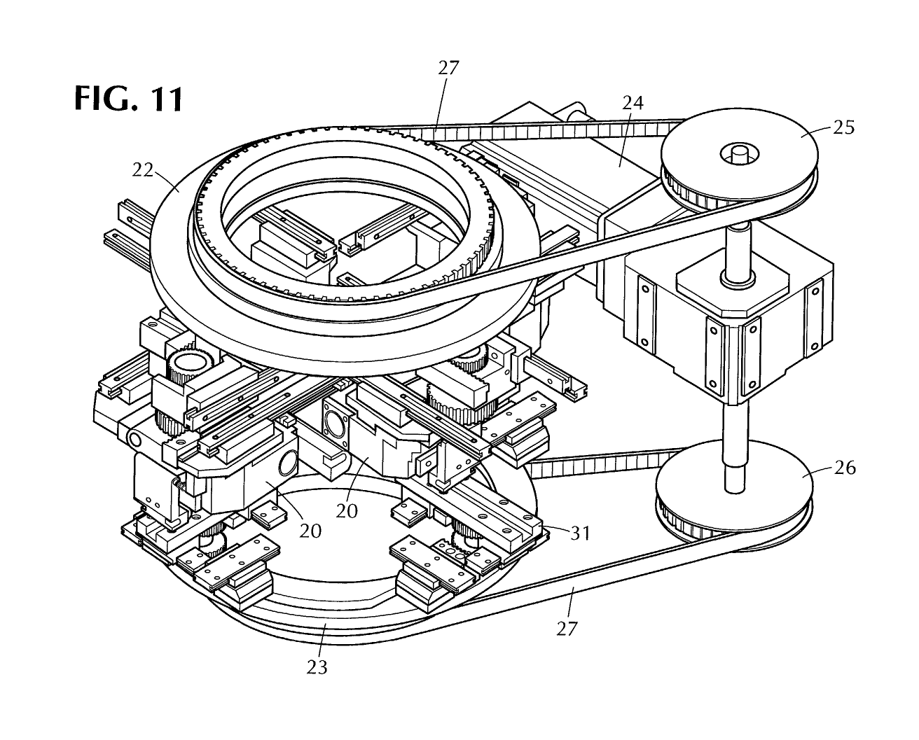

In FIG. 7, as the film comes off the forming shoulder 1, the film travels around the outer circumference of the form-and-fill tube 2 and a portion of the film travels down the rear section of the form-and-fill tube 2, and over the ears 7. The pleat seal back-up plate 8 (shown in FIG. 9) moves the film in the back of the tube into the valley between the ears 7 of the form-and-fill tube 2. The film wraps around the ears 7. The vacuum belts 3 move the film downward, and as the film moves downward, the ears of the form-and-fill tube 2 taper off. The film coming off of each ear 7 is drawn through the lead-in funnels 9, and in between the pleat seal heating blocks 10 (both shown in FIGS. 9 and 10), which transfer heat to both sections of the folded film. FIG. 9 illustrates that after the film is heated and brought together, each side of the film travels into a set of pleat-nip wheels 12, which pinch the film, and apply pressure to the film, thereby creating a hard crease and a pleat seal at the bottom of the stand-up pouch. The two pair of pleated nip rollers 12, which are driven by the servo-motor 13 through a gear train, also help to draw the film down the form-and-fill tube 2 along with the vacuum belts 3. As the film travels on down the form-and-fill tube 2, it leaves the form-and-fill tube 2 and the vacuum belt 3 with a fin seal on the top, and pleat seals on the bottom, of the stand-up pouch (shown in FIG. 20) and moves into the sealing head assembly (shown in FIG. 11), where the sealing and cutting of the sides of the stand-up pouch will occur.

The description provided above primarily relates to a form-and-fill assembly of this invention that is used to make a stand-up type pouch. It should be clear, however, that minor changes may be made to the components of the assembly to form other types of packages such as a can-type, pillow, and tetrahedral package. For example, simply by changing the form-and-fill tube 2, a can-type pouch with dual pleat seals in the front and back of the tube can be made, or a pillow or tetrahedral package with either a single pleat or fin-type seal in the front and back of the tube can be made.

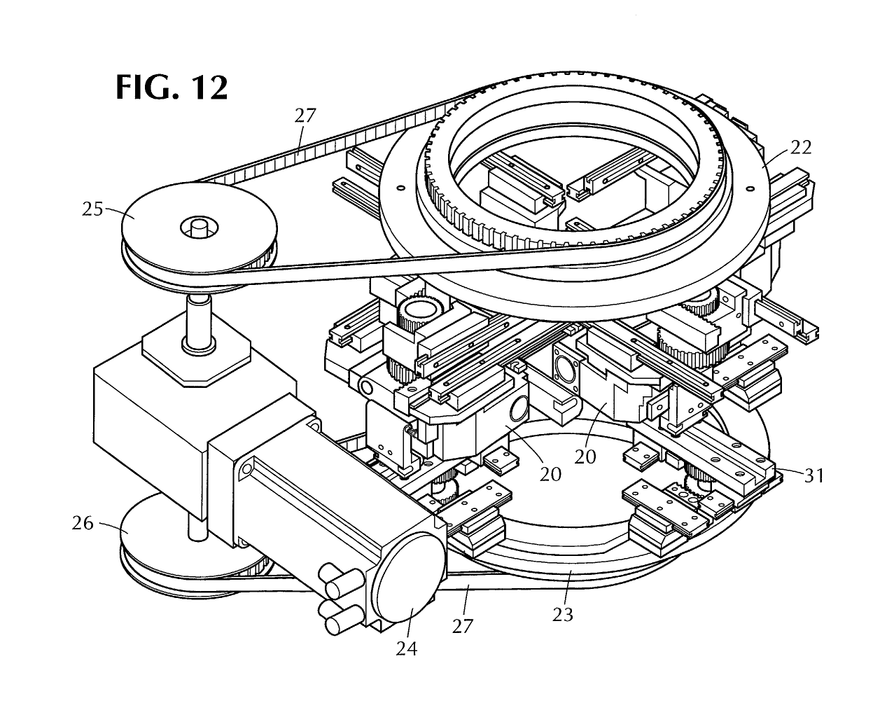

FIGS. 11 and 12 show the major components of the seal assembly. The seal assembly consists of four individual sealing heads 20, or two pairs of sealing heads 20, each pair positioned perpendicular to the other pair. While in operation, the pair of sealing heads 20 will move toward each other until the face of each jaw mates, while rotating the jaw 21 towards and through the film. A pair of sealing heads include jaws 21 that either seal or cut the film based on the position of the jaws. When the jaws 21 are in their uppermost position, a seal is created in the tube of film passing through the center of the seal head 20. However, when the jaws 21 are parallel to each, the tube of film passing through the center of the seal head 20 is cut. After the jaws 21 rotate through the film, the jaws 21 retract, thereby allowing the film to be continually fed and allowing the other pair of jaws 21 to seal and cut the next tube of film, if necessary. The two pairs of seal heads 20 are used in tandem when a tetrahedral-type of package is being produced because the tetrahedral package requires that the jaws 21 be provided 90 degrees apart from each other.

Once the seal head 20 retracts the jaw 21 is then reset in its uppermost position (the sealing position) and is ready to perform the next seal. The actual angular displacement of the jaw 21 during its rotation is in the range of 30 to 40 degrees—approximately 15 degrees above and below the horizontal reference point. The head stroke of the seal head 20 is controlled by the head stroke disk cam 22 that is located above the jaw 21; the jaw's 21 rotation is controlled by the jaw rotation disk cam 23 that is located below the jaw 21. The head stroke and jaw rotation move in unison with one another and are driven by the seal head servo 24 through a common shaft attached to the seal head servo 24 and head stroke cam drive pulley 25 and jaw rotation cam drive pulley 26, respectively. Timing belts 27 connect the head stroke cam drive pulley 25 and jaw rotation cam drive pulley 26 to the head stroke disk cam 22 and jaw rotation disk cam 23, respectively. The seal heads 20 are removable, and a pair would be removed if, for example, a tetrahedral package was not being made.

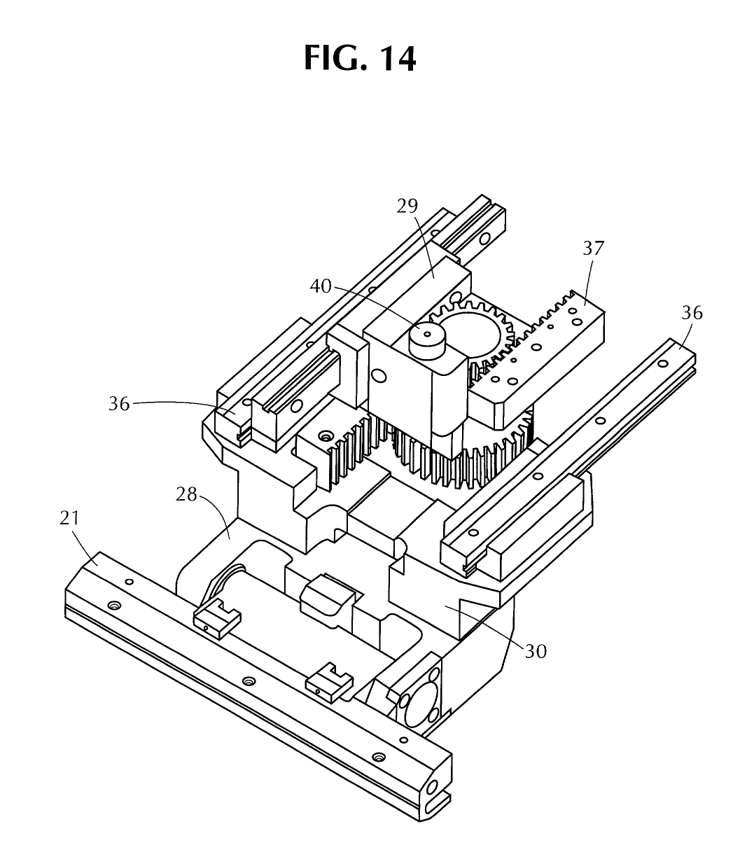

FIG. 14 shows the seal head station 20 without the orthogonal velocity mechanism (described below). Each individual seal head station 20 comprises: a housing 28, which holds the mechanical components in relation to one another; a jaw 21, which contains a shaft, a body, a knife/anvil, and a helical gear section; a stroke multiplier assembly 29, which controls and amplifies the linear translation of the housing 28; and a seal housing slide mount 30, which serves as a carriage to mount the housing for engagement with the stroke multiplier assembly 29.

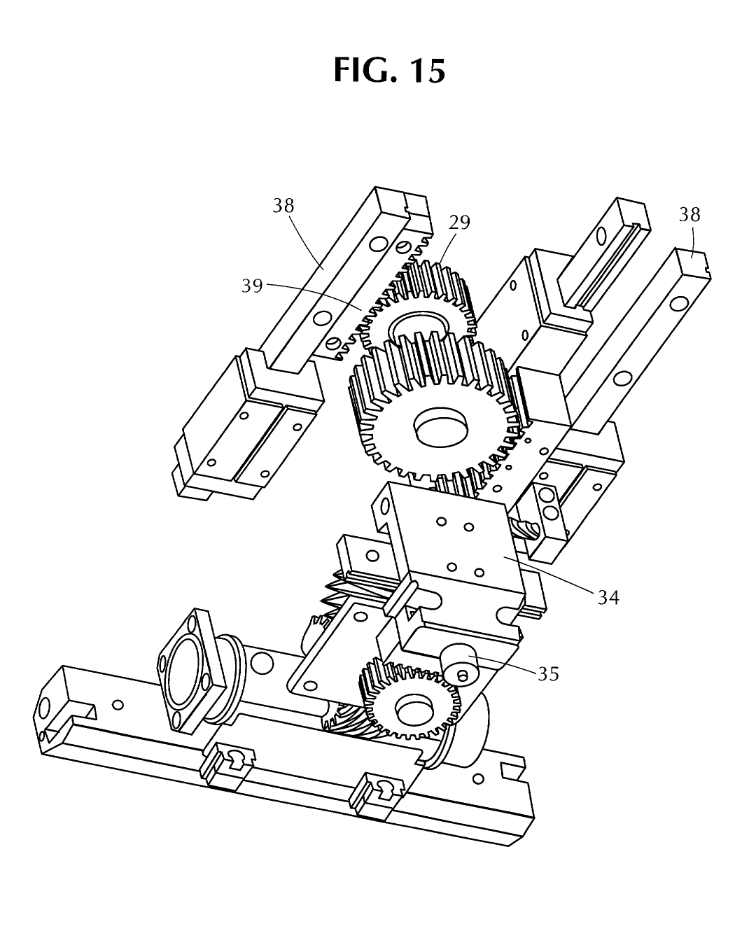

In FIG. 14, the housing 28 holds all the elements of the sealing head 20. The main helical gear 32 inside the housing 28 engages the helical gear 33 section on the jaw's 21 shaft. On the same shaft as the main helical gear is a spur gear which is engaged in the gear rack of the jaw stroke slide 34, which is shown in FIG. 15. The jaw stroke slide 34 contains a cam follower 35 that rests in the orthogonal velocity mechanism 31. As the orthogonal velocity mechanism 31 manipulates the jaw stroke slide, the movement of the slide and rack imparts a rotation to the spur gear, which transfers the rotation to the helical gear 32 inside the housing 28 and out to the jaw 21. The seal housing slide mount 30 is located above the housing 28. The seal housing slide mount 30 is a carriage that is mounted to linear bearings 36, which the seal head 20 is mounted to. This arrangement lets the housing 28 move to and from the sealing zone continuously. There is also a gear rack 37 fixed to the seal housing slide mount 30, which engages the stroke multiplier assembly 29.

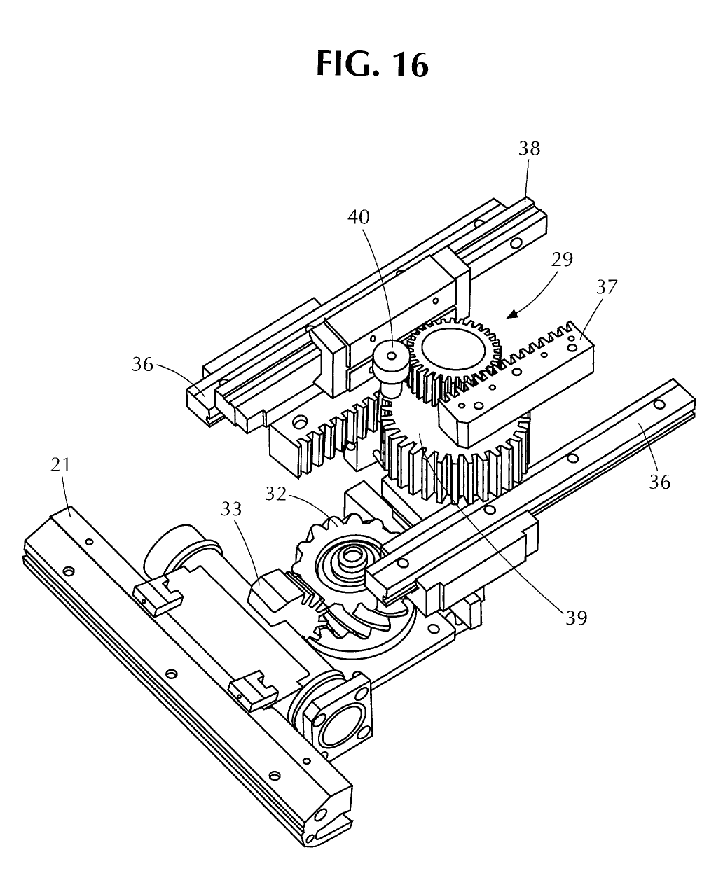

The stroke multiplier assembly 29 shown in FIGS. 15 and 16 is a small differential gearbox that is located on its own linear bearing 38. It has a housing that holds a shaft that drives an upper gear 39 and a lower gear 49. These gears may have different, or 1-to-1, pitch diameters. The lower gear 49 engages the seal housing slide mount 30 and the upper gear 39 engages both the static multiplier gear rack 37 mounted to the frame of the seal head 20, and a head stroke cam follower 40. The cam lead stroke follower 40 rides in the groove in the head stroke disk cam 22.

As the head stroke disk cam 22 rotates, it displaces the stroke multiplier assembly 29. As the stroke multiplier assembly 29 moves, the shaft is rotated by the engagement of the spur gear in the static multiplier gear rack 41 and the rotation is translated through the shaft into the upper gear 39 or lower gear 40. These two movements, that is, the linear translation and angular rotation of the jaws 21, amplify the stroke and velocity to the seal housing slide mount 30 moving it in or out.

The orthogonal velocity mechanism 31 shown in FIGS. 11-13 controls the angular rotation of the jaw. The orthogonal velocity mechanism 31 imparts the movement to the seal head 20 for jaw rotation. The orthogonal velocity mechanism 31 is linked to the seal head 20 through the engagement of the cam follower on the jaw stroke slide cam follower 35 in the slot of the jaw rotation slider cam 43 of the orthogonal velocity mechanism 31. The orthogonal velocity mechanism 31 changes the direction of the linear motion that is perpendicular to the input. For example, the orthogonal velocity mechanism 31 changes the input from the north to the south direction, and the output from the east to the west direction. This allows the jaw 21 of the seal head 20 to operate separately from the head stroke.

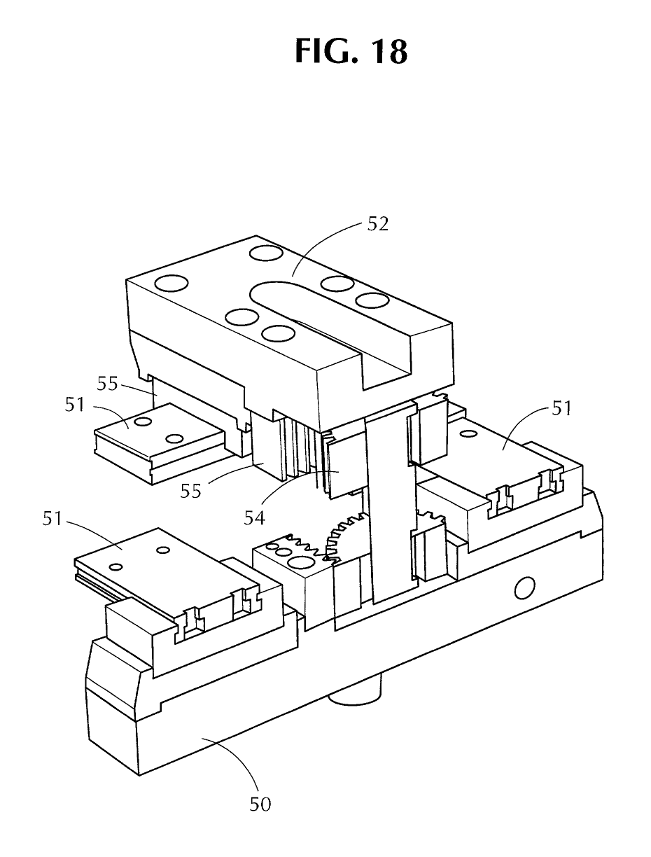

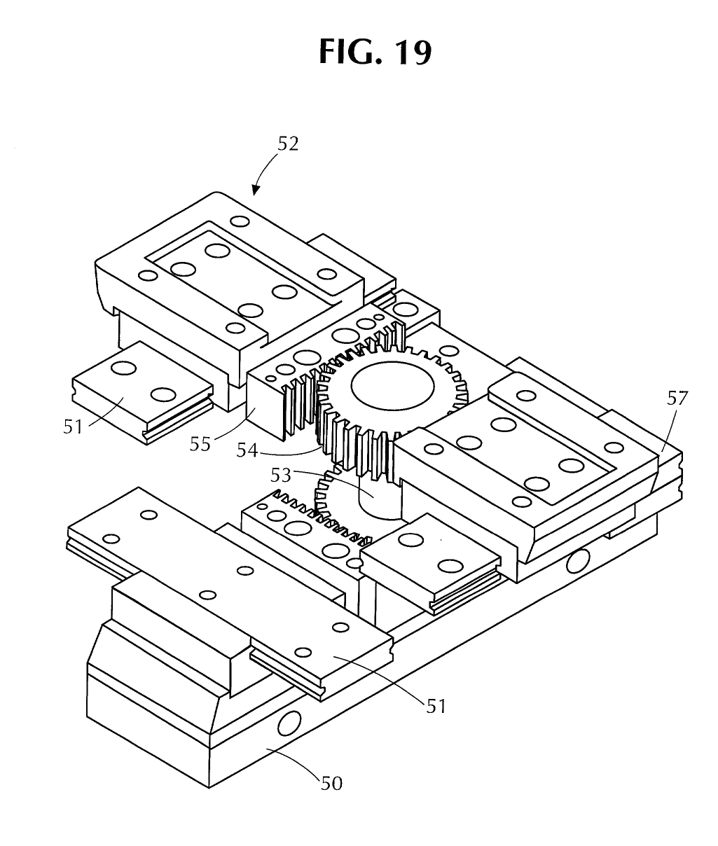

FIGS. 18 and 19 show the arrangement of the orthogonal velocity mechanism 31. The jaw cam follower slide 50 is on the underside of the orthogonal velocity mechanism 31 assembly. It consists of a tooling plate with a cam follower mounted therein, two linear bearings 51 mounted on each side of the jaw cam follower slide 50, and a section of gear rack mounted on the side opposite the jaw cam follower slide 50. The jaw cam follower slide rides in the groove of the jaw rotation slider cam 52.

The jaw rotation slider cam 52 is on the upper side of orthogonal velocity mechanism 31 assembly. It consists of a tooling plate with a slot or groove cut into it (to engage the cam follower on the jaw stroke slide), two linear bearings 51 on either end, and a section of gear rack mounted to its under side.

A shaft 53, running through the base plate of the assembly, has a spur gear on each end, which engages and links the jaw cam follower slide 50 and the jaw rotation slider cam 52 by the engagement of the slider gear 54 and slider rack 55.

As the jaw cam follower slide cam 50 is displaced by the jaw rotation disk cam 52, the tooling plate moves. The rack-and-pinion gear arrangement rotates the shaft 53 and the opposite side gear. Since it is mounted perpendicular to the other tooling plate, the jaw rotation slider cam 52 translates, then displaces, due to its rack-and-pinion arrangement, in a direction 90 degrees from the input.

FIG. 20 shows a view of the stand-up pouch made by the first embodiment of the present invention in the orientation that it is in as it goes through the apparatus. The fin seal 61 is located at the top of the pouch and the dual pleat seals 62 are located at the bottom of the pouch 63. The side seals 60 are formed by the jaws 21.

FIG. 21 shows a view of the can bag in the orientation that it is in as it goes through the apparatus. The dual pleat seals 62 are located at the top and bottom of the pouch. The side seals 60 are formed by the jaws 21.

FIG. 22 shows a view of the pillow-type bag. The seals at the top and bottom of the bag may be single pleat seals 62 or fin seals 61. The side seals 60 are formed by the jaws 21.

FIG. 23 shows a view of the tetrahedral package. The longitudinal side seals may be single pleat seals 62 or fin seals 61. The seals at the top and bottom of the package are formed by the jaws 21.

We claim:

1. A vertical form, fill, and seal apparatus for making packages, said apparatus comprising:
a vertical form and fill tube;
a first sealing mechanism positioned on a first side of said tube;
a second sealing mechanism positioned on a second side of said tube different from said first side of said tube; and
at least one horizontal sealing mechanism.

2. The apparatus according to claim 1, wherein said first sealing mechanism, said second sealing mechanism, and said horizontal sealing mechanism are used separately, or in combination, to make different types of packages.

3. The apparatus according to claim 1, wherein said first sealing mechanism or said second sealing mechanism may be a pleat sealing mechanism.

4. The apparatus according to claim 1, wherein said first sealing mechanism or said second sealing mechanism may be a fin sealing mechanism.

5. The apparatus according to claim 1, wherein the first side of said tube is opposite said second side of said tube.

6. The apparatus according to claim 1, wherein said horizontal sealing mechanism includes a cutting element.

7. The apparatus according to claim 1, wherein said horizontal sealing mechanism comprises two horizontal sealing mechanisms in perpendicular alignment.

8. The apparatus according to claim 1, wherein said tube includes one or more raised portions for forming a seal in the package, and
wherein said tube includes a horizontal portion between said raised portions for forming the seal in the package.

9. The apparatus according to claim 1, wherein the type of packages made by said apparatus comprise stand-up, can, pillow, tetrahedral, and similar types of packages.

10. A form-and-fill tube comprising:
a tube for forming a package on the outside of said tube,
wherein a product travels through the inside of said tube,
wherein said tube includes one or more raised portions for forming a seal in the package, and
wherein said tube includes a horizontal portion between said raised portions.

11. The form-and-fill tube according to claim 8, wherein said raised portions are tapered.

12. A horizontal sealing mechanism for sealing at least one side of a package, said mechanism comprising:
a jaw unit, said jaw unit comprising at least one pair of jaws capable of moving horizontally in an inward and outward direction,
wherein said jaw unit moves inward until the pair of jaws mate;
a drive unit, said drive unit being capable of moving said jaw unit; and
a rotation unit, said rotating unit being capable of rotating said jaw unit vertically in an upward and downward direction,

13. A mechanism according to claim 12, wherein said rotation unit is capable of rotating said jaw unit in a vertical range of 30 to 40 degrees.
